(19) United States
(12) Patent Application Publication
(10) Pub. No.: US 2022/0244426 A1
(43) Pub. Date: Aug. 4, 2022

(54) PRECIPITATION MEASUREMENT METHOD AND DEVICE

(71) Applicant: HD RAIN, Bonneuil-Sur-Marne (FR)

(72) Inventors: Ruben Hallali, Paris (FR); Dumminda Ratnayake, Colomiers (FR); François Mercier, Maisons-Al-Fort (FR)

(21) Appl. No.: 17/595,377

(22) PCT Filed: May 4, 2020
(86) PCT No.: PCT/FR2020/050742

§ 371 Date: Nov. 15, 2021

(30) Foreign Application Priority Data
May 15, 2019 (FR) 1905057

(51) Int. Cl. G01W 1/14; G01W 1/10

(52) U.S. Cl. CPC G01W 1/14; G01W 1/10

(57) ABSTRACT

A method for measuring precipitation comprises: acquiring, from at least one coordinate (x,y,z) acquisition site PA, at least one radio signal transmitted from at least one radiofrequency transmission source and periodically measuring the power P(t) of a component of the received signal in order to create series of time-stamped levels (P(t),t) processing, on at least one sliding temporal window, N values of at least one time-stamped series (P(t),t), which includes, on the one hand, determining the type of hydrometeors that are in play (rain, hail, snow, etc.) and determining a reference level for the signal corresponding to the power of the signal that would be received from the transmitter in the absence of hydrometeors and denoted (Pref(t),t) and calculating a sequence of rainfall attenuations (or due to other hydrometeors) (ΔP(t),t) according to: ΔP(t)=P(t)−Pref(t). An acquisition device is used for implementing the method.

### CROSS-REFERENCE TO RELATED APPLICATIONS

This application is a national phase entry under 35 U.S.C. § 371 of International Patent Application PCT/FR2020/050742, filed May 4, 2020, designating the United States of America and published as International Patent Publication WO 2020/229753 A1 on Nov. 19, 2020, which claims the benefit under Article 8 of the Patent Cooperation Treaty to French Patent Application Serial No. FR1905057, filed May 15, 2019.

### TECHNICAL FIELD

The present disclosure relates to the qualitative and quantitative evaluation of precipitation and to its temporal and geographical distribution. Rainfall can currently be determined using various instruments, for example, rain gauges placed on the ground that collect the rain in calibrated containers, or even meteorological radars that measure the rate of precipitation by the backscattering effect.

### BACKGROUND

It has also been proposed to exploit the effect of precipitation on the propagation of radiofrequency transmissions, since microwaves (1 GHz to 300 GHz) are partly absorbed by water, and more particularly by liquid or solid water from precipitation. This technique, based on Mie scattering theory, makes it possible to deduce information of meteorological interest from the measurement of the absorption of a part of radio signal traveling in the atmosphere.

In particular, it has been proposed to exploit the signals broadcast by the numerous geostationary satellites intended for TV-SAT networks that transmit in the Ku frequency band (10.7 GHz to 12.75 GHz), where the signal is significantly weakened by precipitation, typically by 2 dB per kilometer for heavy precipitation (50 mm per hour).

It is also observed that, in the absence of an intentional transmitter in the sight of an electromagnetic sensor, in particular, of the satellite type, the raindrops and other hydrometeors themselves emit as a result of Planck radiation, and also of the Mie scattering of all the signals that come into contact with the observed hydrometeors.

These emissions can also be used to detect and quantify hydrometeors in the sight of the sensor used.

The article “Rainfall measurement from the opportunistic use of an Earth-space link in the Ku band,” authors Barthès, L. and Mallet, C. in the journal Rainfall measurement from the opportunistic use of an Earth-space link in the Ku band, Atmos. Meas. Tech., 6, 2181-2193, https://doi.org/10.5194/amt-6-2181-2013, 2013, is known in the state of the art. This article deals with the development of a low-cost microwave device dedicated to the measurement of average rainfall rates observed along Earth-satellite links, characterized by a tropospheric path length of a few kilometers. Ground power measurements, which are taken using Ku-band television transmissions from a plurality of different geostationary satellites, are based on the principle that the atmospheric attenuation produced by rain encountered along each transmission path can be used to determine the average rainfall on the rate path. This type of device could be very useful in hilly regions where radar data are not available or in urban regions where these devices could be placed in homes directly using a residential TV antenna.

This article explains the main difficulty encountered with this technique, which is to find the characteristics of precipitation in the presence of numerous other causes of fluctuation in the received signal, produced by atmospheric scintillation, variations in atmospheric composition (water vapor concentration, cloud water content) or satellite transmission parameters (variations in transmitted power, satellite pointing).

This article describes an algorithm based on an artificial neural network, used to identify dry and rainy periods and to model the variability of the received signal resulting from effects unrelated to rain. It states that when the altitude of the rain layer is taken into account, the attenuation of the rain can be inverted to obtain the average rainfall rate on the path. It proposes comparing the rainfall rates obtained from this process with co-located rain gauges and radar measurements taken throughout the campaign, and the most important rainfall events are analyzed.

The following publications are also known:
The doctoral thesis “Variational assimilation of multi-scale observations: application to the fusion of heterogeneous data for the study of the micro- and macrophysical dynamics of precipitating systems” defended on May 7, 2016 at the University of Paris-Saclay. This prior art document describes a solution based on data assimilation in order to link heterogeneous observations of precipitation and models, so as to study precipitation and its spatio-temporal variability at different scales (macrophysics, which deals with rain cells, and microphysics, which deals with the drop size distribution—DSD—which forms them). First, it develops an algorithm for rendering rainfall maps from measurements of the attenuation caused by rain to waves coming from television satellites. Its renderings are validated against radar and rain gauge data over a case study in the south of France. Then, it renders, again by data assimilation, vertical profiles of DSD and of vertical winds from measurements of drop flow on the ground (by disdrometers) and Doppler spectra at altitude (by radar).
François Mercier, Laurent Barthès, Cécile Mallet. Estimation of Finescale Rainfall Fields Using Broadcast TV Satellite Links and a 4DVAR Assimilation Method. Journal of Atmospheric and Oceanic Technology, American Meteorological Society, 2015, 32 (10), pp. 1709-1728. (10.1175/JTECH-D-14-00125.1). <insu-01157488>. This study proposes a method based on the use of a set of commercial satellite-Earth microwave links to reconstruct finescale rainfall fields. Microwave links exist worldwide, and can be used to estimate the integrated rain attenuation over the first 5-7 kilometers of the links at a very high temporal resolution (10 s in this case). The recovery algorithm uses a four-dimensional variational data assimilation (4DVAR) method involving a numerical advection scheme. The advection speed is recovered from observations or radar precipitation fields at successive time steps. This technique was successively applied to simulated 2D rain maps and to real data recorded in the fall of 2013 during the Hydrological Cycle in the Mediterranean Experiment (HyMeX), with a sensor receiving microwave signals from four different satellites. The performance of this system is evaluated and compared with an operational Météo-France radar and a network of 10 rain gauges. Due to the limitations of the propagation model, this study is limited to events with strong advective characteristics (four events recorded out of eight). For these events (only), the method produces precipitation fields strongly correlated with radar maps at spatial resolutions greater than. The point scale results are also satisfactory for temporal resolutions greater than 10 min (average correlation with rainfall data of about 0.8, similar to the correlation between radar data and rainfall data).

Drawbacks of the Prior Art

The prior art solutions are not satisfactory because they are very sensitive to the propagation conditions, which vary for many reasons and not just because of the presence of rain. In reality, the attenuation varies throughout the day, sometimes erratically, and the evaluation resulting from the method proposed by this patent is therefore largely invalidated by these variations.

The solution proposed in the article “Rainfall measurement from the opportunistic use of an Earth-space link in the Ku band” proposes a solution intended to provide rainfall information on the basis of data collected over a determined period, during which significant variations may have occurred. It therefore only provides static, fixed information, without taking into account the development of the rainfall over time.

Furthermore, the prior art solutions are not satisfactory because they do not take into account the fall delay of the drops of water (or other hydrometeors) as well as their horizontal displacement during this fall. Having information on the speed of movement of rain cells is also crucial, both for evaluating the movement of drops and for linking measurements taken at different dates/places.

In addition, these solutions are not suitable for real deployment in the field because they require the installation of a satellite dish outside in order to be able to receive satellite signals and then require accessing a power supply and a reliable communication network, elements that in most cases are located inside the building. This passage from the outside to the inside of the building, without compromising the tightness of its roofing, leads to many potential installation sites being eliminated.

Finally, as a result of the need to target a satellite transmitting correctly over the region of interest, the existing solutions do not allow the measurement to be oriented in all directions from the acquisition site, but constrain it in the direction of a subset of the orbit of the geostationary satellites.

### BRIEF SUMMARY

Solution provided by the present disclosure

In order to respond to these drawbacks, the present disclosure relates, in its most general sense, to a method for measuring precipitation comprising:
acquiring, from at least one coordinate (x,y,z) acquisition site PA, at least one radio signal transmitted from at least one transmitter and periodically measuring the power P(t) of a component of the received signal in order to create a series of time-stamped levels (P(t),t);
performing processing, over at least one sliding temporal window, N values of at least one time-stamped series (P(t),t), potentially combined with other time series (Mp(t),t) of environmental parameters at or close to the acquisition site (temperature, pressure, humidity, wind, etc.) or parameters relating to the system (satellite dish & LNB temperatures, supply voltage, etc.) which involves, on the one hand, determining the type of hydrometeors that are in play (rain, hail, snow, etc.) and leads, on the other hand, to determining a reference level for the signal corresponding to the power of the signal that would be received from the transmitter in the absence of hydrometeors and denoted (Pref(t),t); and
calculating a sequence of power fluctuations due to rainfall (or due to other hydrometeors) (ΔP(t),t) in accordance with:

ΔP(t)=P(t)−Pref(t).

The advantage of processing of this type is that it allows real-time dynamic determination of the reference level Pref(t).

This reference level may be determined, simultaneously or otherwise with the identification of the hydrometeors that are in play, by carrying out processing comprising:
determining the start or end dates of the period with precipitation as a function of the variance, of the speed of variations, and in general of the signature of the values (P(t),t).

For example, the signature could be calculated from the effective value of a digital filtering of the values (P(t),t) over a defined band of low frequencies.
determining Pref(t) in accordance with the following cases:
   between the start tdj and end tfj times of periods with precipitation, Pref(t) corresponding to an interpolation between (P(tdj),tdj) and (P(tfj),tfj)
   between the end time of precipitation tfj and the start time of following precipitation tdj+1:

Pref(t)=P(t)
after a start of precipitation tdj the corresponding end of which has not yet been detected:

Pref(t)=P(tdj))

Advantageously, this determination step is carried out by a neural network.

This reference level could, in another variant, be determined, simultaneously or otherwise with the identification of the hydrometeors that are in play, directly from the measurements P(t), from the measurement of other environmental parameters close to the acquisition site (for example, the air temperature or humidity or the temperature of the antenna) and from taking into account parameters relating to the system (temperatures of the elements of the sensor, supply voltage, etc.), advantageously using a neural network that is supervised and therefore trained against reference data (radar, rain gauges).

Preferably, in the case of rain, the following steps are also carried out:
Acquisition of the altitude Zo of the 0° C. isotherm
Calculation of Lo, the distance traveled by the signal below the 0° C. isotherm, as a function of the altitude Zo and the geometry of the problem
Determination of the rainfall rate

$${R ( t )}_{t} = \sqrt[b]{\frac{k , \vert Δ {P ( t )}_{t} \vert}{Lo}}$$

Where:
R denotes the rainfall rate in millimeters per hour
Lo denotes the distance traveled by the signal below the 0° C. isotherm
ΔP(t) denotes the fluctuation of the received power in decibels
b and k denote coefficients depending mainly on the frequency, the polarization of the radiofrequency signal, and the drop size distribution.

Other parameters linked to the geometry of the problem (angle of incidence of the wave on the drops, for example) and environmental parameters (water temperature, for example) are also likely to influence them to a lesser extent. In the context of this patent, taking measurements at a plurality of frequencies and under a plurality of polarizations will advantageously make it possible to adjust the rainfall rate renderings R.

Multi-polarization measurements also make it possible to render the characteristic sizes of raindrops by identifying the vertical and horizontal components of the attenuation, since the shape of the drops is a function of their size.

The matter of the radio signal transmitter is also of importance. The transmitter can thus be a geostationary TV or internet transmission satellite, in the Ku, Ka or V frequency band. In this case the power fluctuation due to the hydrometeors that is measured by the system corresponds to the loss of signal between the transmitter and receiving antenna. It has been found that the transmitter could nevertheless also be formed by the raindrops themselves, if the acquisition station is aimed not at a satellite but, for example, at the empty sky. Specifically, by Planck radiation, the drops emit a maximum signal in the infrared but also a weaker signal in the radiofrequencies. The Mie scattering of electromagnetic signals colliding with hydrometeors in the viewing angle of the antenna also produces a signal in the direction of the antenna. In the Ku band, for example, this signal focused by an antenna is measurable (radiometric measurement). In this case, the rain therefore causes an increase in the power of the received signal. Inverting this signal (i.e., P(t)=−Preceived(t)), brings about the same situation as for an “artificial” transmitter such as a satellite.

The present disclosure also relates to the applications of the aforementioned method, in particular, for rendering precipitation maps on the ground (step 140).

For this purpose, the average rainfalls R(t) provided by the aforementioned method are projected onto the ground as a function of the altitude Zo and of the speed/fall trajectory pair. The correct determination of the falling conditions of the raindrops are advantageously deduced from information on the local wind, calculated information.

This method is repeated for each acquisition device STATION′ and is characterized in that the projections on the ground of the rainfall rate Rx,y,z (t) are determined as a function of:
the attenuation values (ΔP(t),t)ᵢ corresponding to the devices STATIONᵢ,
the length Loᵢ(t) of the segment of the STATIONᵢ-transmitter link Eᵢ between the ground and the altitude Zo(t) of the 0° C. isotherm.

In a variant, the step of determining the projections on the ground of the rainfall rate Rx,y,z(t) is also a function of time, and of the direction, speed and fall trajectory of the drops in the volume comprising the positions of the devices.

The present disclosure further relates to the use of this method for producing a precipitation map (step 140), comprising determining, from a plurality of acquisition devices STATIONᵢ, the rainfall intensity data on the ground.

Advantageously, the step of determining the rainfall maps on the ground is also a function of a model representing the state of the atmosphere A(t), over the volume comprising the positions of the acquisition devices STATIONᵢ, and the application of data assimilation processing.

Advantageously, the step of determining the rainfall maps on the ground may, in addition to the rainfall measurements taken by the method described above, integrate rainfall data measured by other instruments (for example, rain gauges, meteorological radars, meteorological satellites, opportunistic data deduced, for example, from webcam images). The application of data assimilation processing is particularly well-suited to a method of this type for merging data of different types.

Advantageously, one or more server computers controls the processing operations including:
estimating the speed of movement of the rain cells by a direct estimate from the temporal data ΔP(t)i of fluctuations in received power, calculated from the data P(t)i measured by the various measurement stations PAᵢ that are geolocated (x,y,z)ᵢ and recorded by the different sensors
calculating a projection on the ground of the rainfall measurements taken by each measurement station PAᵢ, taking into account the position of the sensor, the altitude Zo of the 0° isotherm, the rate of fall of the raindrops, and the speed of movement of the rain cells.
periodically, at a frequency 1/Tf, rendering the rain map on the ground by a step of merging the measurements taken by a significant number of measurement stations STATIONᵢ, over a period [t−T:t] (where T>Tf), to produce a ground rainfall map over the region around the sensors over the period [t−Tf:t].

In an advantageous embodiment, the estimation of the speed of movement of the rain cells involves estimating, for each pair of measurement stations (STATION′, STATIONⱼ), the delay (“lag”) between the start dates of the rain at each of the sensors, and then deducing the movement of the precipitation cells by triangulation from the delays for all the pairs of measurement stations.

In a variant, the estimate of the speed of movement of the rain cells is implemented from satellite images of the cloud masses.

In another variant, the estimation of the speed of movement of the rain cells involves modeling the wind at altitude by way of meteorological models.

In a final variant, the estimation is carried out by merging at least 2 of the 3 preceding methods.

The present disclosure also relates to an acquisition module for implementing the aforementioned method, characterized in that it comprises an input for receiving the signal coming from a radiofrequency reception antenna, a possible potentially controllable component that selects a useful part of the signal by potentially transposing it to a lower frequency band, an electronic circuit for measuring the level of the input signal and calculating a digital value representing the level, and communication means for the cable distribution of digital messages comprising one or more elements relating to measurement and to local elements.

In a variant, the module comprises an electric battery and a photovoltaic panel.

In another variant, the module comprises a radiofrequency communication means.

In another variant, it comprises a circuit for placing the radiofrequency communication means on standby and/or for slowing down the periodicity of the measurements, controlled by a signal representing the presence of rain in the sight of the station and/or the state of the station in the short and medium term, in particular, as a function of the amount of energy currently present in the batteries as well as the expected sunshine.

Preferably, the module comprises a means for controlling the periodic variation of the polarization of the receiver, or for simultaneous listening, in order to obtain information on the shape and size of the drops.

In another variant, the device comprises a means for controlling the periodic variation of the polarization and/or frequency band of the LNB head, or its equivalent, in order to measure the different components of the received signal.

In a particular embodiment, it also comprises a thermal protection means (12) with the aim of minimizing the temperature variations of the system, in particular, of the LNB head and/or of the batteries.

In a final variant, it has at least one sensor, in particular, a temperature sensor, supplying the computer with local parameters with the aim of eliminating the unwanted contributions from the measurement of the signal.

The novel technical effects of the present disclosure relate, in particular, to the following aspects:
1— the station's autonomy in terms of energy and in terms of the communication network, in particular, the periodic placing of the receiver on standby to save energy: this solution makes it possible to resolve installation difficulties (cable passage, cable length) and to carry out installations in the open countryside.
2— the potential implementation of a local means for detecting rain (local neural network, etc.) in order not to transmit data continuously unnecessarily if connectivity resources are limited.
3— the use of a plurality of polarizations and frequencies (for example, high and low parts of a broadcasting band) in order to obtain information on the shape of hydrometeors, which makes it possible to deduce information on their size (for agriculture, for example, splashing problems) and to improve the attenuation—rainfall relationships as well as the calculation of the fall time of the hydrometeors.
4— the taking into account of the fall time of the rain and/or its movement during the fall, which makes it possible to take into account the geometry of the problem and to render rain maps on the ground more reliably.
5— the protection of the elements and the correction of the measurement relative to the temperature measured locally or determined externally (and potentially other data) in order to eliminate unwanted contributions to the power measurement.
6— the determination of the speed of movement of the precipitation cells by merging multi-source data.

### BRIEF DESCRIPTION OF THE DRAWINGS

The present disclosure will be better understood upon reading the following detailed description of a non-limiting example of the present disclosure, with reference to the accompanying drawings, in which:

FIG. 1 is a schematic view of a device according to the present disclosure

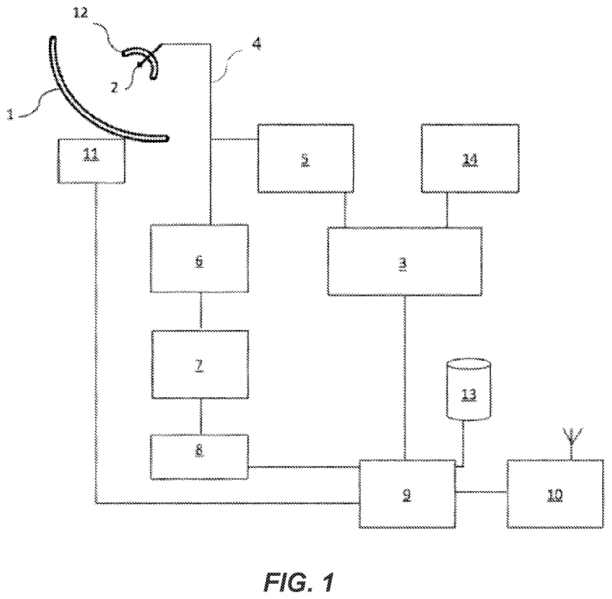

FIG. 2 is the flowchart of the measurement and mapping method according to the present disclosure.

### DETAILED DESCRIPTION

1. Measurement Station

A measurement station includes a satellite dish (1), a universal satellite reception head (LNB) (2), local sensors, and finally an electronic box. The box makes it possible to obtain a digital image of the power of the signal and/or of its fluctuation mainly due to rain, and to transmit these data to the data concentration server(s).

The present disclosure is preferably implemented with an opportunistic solution comprising exploiting the transmissions in the Ku, Ka or V band broadcasting bands transmitted by several hundred currently deployed geostationary satellites.

Each measurement station comprises a STATIONi acquisition device, including a conventional satellite dish (1) equipped with a universal satellite reception head (LNB) (2), hereinafter LNB head. The LNB heads may have two independent outputs (or more) to supply a plurality of digital terminals independently.

A power supply (3) connected to the local electrical installation powers the LNB head (2) via the single coaxial drop cable (4), via a low-pass filter, in this case an inductor (5).

The received signal is transmitted to a preprocessing circuit (6), which performs pre-amplification and filtering with the aim of eliminating parasitic signals, DC components and low frequencies, but also of selecting a frequency or a set of particular frequencies.

The signal thus filtered is then converted into a voltage imaging its power by means of the logarithmic detector (7), this value then being digitized by an analog/digital converter (8) controlled by a microcontroller (9).

The microcontroller receives the signals digitized according to the I2C protocol and calculates a digital value representing the level of the selected component of the signal over a determined period, so as to prepare a digital message comprising the information relating to the measurement and to the local parameters, which is transmitted to the telecommunications unit (10), for example, a Wi-Fi or Ethernet circuit. The periodicity of transmission of this circuit (10) is controlled by the microcontroller (9).

The transmitted messages may contain:
the digital image value of the power
an identifier IDi of the acquisition device STATIONᵢ
the instantaneous position of the STATIONᵢ
information on the measured components of the signals
information on the transmitter(s) listened to
information relating to local weather conditions (temperatures, humidity, sunshine, etc.)
information relating to the results of calculations carried out locally, etc.

In a variant, the microcontroller (9) also controls the power supply (3) in order to select the component of the signal to be measured. This control involves activating the modes of the LNB head (13V, 18V, with or without tone at 22 KHz) in a fixed or sequential manner.

In this case, the measured signal level is associated with an active mode indicator. This sequential control makes it possible to carry out measurements in a plurality of frequency bands and in two polarizations, horizontal and vertical. The combination of the measurements thus carried out makes it possible to obtain information on the characteristic size (or volume) of the hydrometeors (step 200), this being information that is relevant per se (for matters of impact on crops, for example) and that will also subsequently make it possible to refine the determination of the type of hydrometeor that is in play (rain, snow, hail, etc.) and, where applicable, of the rainfall rates and their projections on the ground.

The information of the digital message broadcast by the circuit (10) may also include other parameters calculated or measured locally by a set of sensors (11) located in the immediate environment of the station, such as the temperature of the LNB head (2) measured by a thermal sensor positioned on the latter.

In a particular variant, the device may also include a geolocation module (one of the elements of the set of sensors (11)), for example, GPS, which can be activated by a remote server and the receiver of the telecommunication module (10), or else broadcast periodically at low frequency by the station, to allow the geolocation of devices in the field by the server. The remote activation of this module then comprises ordering, via the microcontroller (9), the transmission of a message comprising the coordinates provided by the GPS module, this message possibly being shared with other information.

The microcontroller (9) can also control placing on standby or turning off certain functions, in particular, the powering of the LNB head (2), the broadcasting module (10) in order to reduce the power consumption in a conditional manner, for example, when a message transmitted by a server commands switching to standby mode, when a local calculation (carried out, for example, by the local neural network, if present) on the measurements or a hygrometry or brightness sensor of the set of sensors (11) indicates an absence of precipitation, or even as a function of the precipitation history, thus leading to an adaptation to the frequency of switching to the active mode and to the length of the standby periods.

In a variant, the electronic circuits are integrated into one or more thermoregulated boxes with, for example, a phase change material having a melting point of between 15° C. and 40° C.

In a final variant, the protection of the system is one or more sun visor hoods that are impermeable to precipitation and/or fitted with thermal insulation.

2—Alternative: Measurement Station without Artificial Transmitter

In one of the variants of the present disclosure, the measurement station does not pick up the transmissions coming from a targeted “artificial” source (satellite, telecom relay antenna, etc.) but rather the signal emitted by the raindrops themselves.

The signal may be due to Planck radiation (black body radiation); indeed, the drops emit over the entire electromagnetic spectrum, with a maximum power signal in the infrared but also a weaker signal in the radiofrequencies. In the Ku band, for example, this signal focused by an antenna is measurable (radiometric measurement).

The signal may also be due to Mie scattering on the hydrometeors present in the region targeted by the sensor, when the latter are reached by any electromagnetic signal passing through the region.

In this case, the acquisition station (in this case a satellite dish) is not aimed at a satellite but at the empty sky. In the absence of rain, the “raw” power measurement Preceived(t) consists of atmospheric or electronic noise. The rain then causes an increase in the power of the received signal. By inverting this signal (i.e., P(t)=−Preceived(t)), the same situation arises as for an “artificial” transmitter such as a satellite.

All the other points covered by the present disclosure (measurement station and processing chains) are thus similarly applicable in this context.

3. Another Alternative: Autonomous Measurement Station

In one of the preferred variants of the present disclosure, the measurement station has energy autonomy as a result of the addition of a photovoltaic system (14) and communication autonomy as a result of connection to one or more wireless communication networks (2G, 3G, 4G, 5G, LTE/M, LORA, SIGFOX, satellite, etc.).

The information of the messages transmitted by the communication unit (10) can also be stored locally in a database (13) in order to be retrieved later in the event of possible communication problems or else manually in the absence of an affordable communication network at the location served.

This autonomy simplifies the deployment of the stations in the field by reducing the constraints on the deployment sites, in particular, the passage of cable inside the building without affecting the waterproofing of the building, by giving the installation unity of location.

This also makes it possible to improve the quality of the measurement by reducing the length of the cable carrying the signal coming from the LNB head (2). It can also be installed in the open countryside, in places with no electrical access or wired communication network. The device is autonomous in terms of electricity, the power supply (3) being formed by a battery or a supercapacitor connected to a renewable energy source (14), for example, a photovoltaic panel or a wind turbine. This variant makes it possible to equip territories not served by an electricity network.

The autonomous measurement station also includes a processor (9) that performs precipitation estimation processing operations in order to control the power supply (3) and the transmission of data as a function of the state of the precipitation (typically a lower power supply and no transmission if no precipitation over a long period).

The method for estimating precipitation may, in particular, be that described below, but it can also be carried out by other methods.

This alternative makes it possible to limit the amount of digital information to be broadcast, in particular, when the measurement station is installed in a low-connectivity region.

4. Processing Operations on Acquired Data

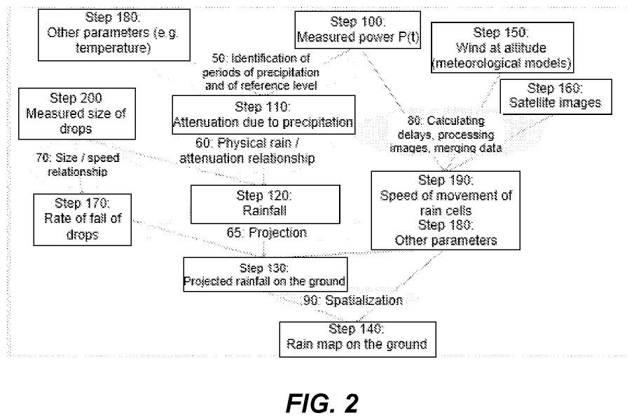

An example of data processing is set out below by way of example, illustrated by FIG. 2, which shows the flowchart.

Certain processing operations are carried out station by station, either directly by the measurement station or by the server on the basis of the data transmitted by the measurement stations.

These operations relate to:
identification of the periods of precipitation and of the reference level (step 50) from the power P(t) measured by the measurement station in question (step 100) and possibly other parameters such as the temperature (step 180), for example, by a “multi-layer perceptron” algorithm or even a recurrent “LSTM” (long short-term memory) neural network.
determination (step 60) of the physical relationship between the rain and the power fluctuation due to the rain (step 110), calculated from the power measured during step (100).
the size of the drops that is determined in step (200) from multi-polarization/frequency measurements makes it possible, by using relationships between the size and the speed of the drops (step 70), to complete the results of the step (110) of measuring power fluctuation due to rain to determine rainfall rates (step 120).
this step (70) also makes it possible to estimate the fall rate of the raindrops (step 170) in order to carry out a projection on the ground of the rainfall (step 120) as a function of the result of step 120.

Furthermore, certain processing operations are carried out not station by station, but rather on the combination of measurements from a plurality of stations, taken globally over a covered region of interest.
The step (80) of calculating delays, processing images, merging data from the result of the power measurement of step (100) and from the upper wind model (step 150) as well as from satellite images (step 160) makes it possible to determine the speed of movement of the rain cells (step 190).
The spatialization (step 90 makes it possible to determine a rain map on the ground (step 140), for example, by a 4D-VAR assimilation algorithm.

In a variant, the combination of the measurements taken by a plurality of stations could be used to detect simultaneous variations in the signal that are not due to hydrometeors and that could thus be filtered. For example, if a single satellite, the transmissions of which are received by a plurality of stations, suddenly changes the power of its transmissions, this sudden change will be detected immediately at the various stations in question (via a correlation search algorithm) and can be corrected in the processing chain.

5. Use of Signals from Acquisition Devices: Determination of Rainfall

The processing operations below can be carried out locally, by a computer of the measurement station, or centrally, by a server. However, operations carried out locally will not generally dispense with centralized operations (more complete and therefore more precise) and will only be used to limit data transmission in the event of installation in a low-connectivity region, as described above.

The messages (P(t),t) broadcast by the acquisition devices STATIONᵢ are collected (step 100) by a server that performs time-stamped recording of these messages that are received in a database.

The processing operations applied to the recorded data are first applied to the data of each of the acquisition devices to determine the attenuation (step 110) due to precipitation and to deduce therefrom the rate of precipitation on the path between the transmitting satellite and the device STATIONᵢ in question.

This processing (step 50) initially comprises eliminating the unwanted contributions to the variability of the received signal, such as that due to the variations in other externally measured or determined environmental parameters (typically the temperature) (step 180). This step is typically performed by a neural network.

This processing (step 50) subsequently comprises identifying in the recorded data the noteworthy points corresponding to a beginning or an end of precipitation.

Noteworthy points can be identified by various methods:

One of the methods is based on the use of a neural network indicating for each date and each STATIONᵢ whether there is precipitation or not. This network takes as input the data recorded by the measurement station over a recent temporal window, or any parameter that can be deduced from these data and that can characterize the presence or absence of precipitation, for example, the variance or the local gradient of the series of measurements. It can also take as input the data coming from another nearby station, as well as potentially other environmental data measured at or close to the stations, for example, the temperature of the air or of the receiving LNB head. This neural network may be supervised or unsupervised. It may thus be, for example, a multi-layer perceptron, a convolutional neural network, or any other system of the same type. If it is supervised, the training data is labeled “precipitation” or “non-precipitation” using independent data that provides knowledge concerning the precipitation, for example, from meteorological radar or rain gauge measurements. The neural network typically outputs a coefficient that can be interpreted as a probability that the input sample matches a date with or without precipitation. A threshold on this probability can then typically make it possible to classify the sample as with or without precipitation.

These noteworthy points are then used in order to calculate a reference level for the signal corresponding to the power of the signal that would be received from the transmitter in the absence of hydrometeors, denoted (Pref(t),t).

A sequence of fluctuations in the power received caused by rainfall (or due to other hydrometeors) (ΔP(t),t) can then be calculated in accordance with:

ΔP(t)=P(t)−Pref(t)

From the noteworthy points, the level Pref(t) is typically determined by this procedure:
between the start tdj and end tfj times of periods with precipitation, Pref(t) corresponds to an interpolation between (P(tdj),tdj) and (P(tfj),tfj)
between the end time of precipitation tfj and the start time of following precipitation tdj+1:

Pref(t)=P(t)
after a start of precipitation tdj the corresponding end of which has not yet been detected:

Pref(t)=P(tdj)

It may also be noted that in a variant of this processing, step 50 is carried out by deducing Pref(t) directly from P(t), from the measurement of other environmental parameters close to the acquisition site (temperature, humidity, etc.) and parameters specific to the system (temperatures of the various elements, supply voltage, etc.), by the application of an “LSTM” neural network, which is supervised and therefore trained with radar or rain gauge data. In this case, the step of determining the noteworthy points is not included.

This processing (step 50) finally comprises identifying, in the event of precipitation, the type of hydrometeors that are in play (rain, snow, hail). This identification step may advantageously be carried out simultaneously with the previous one (“precipitation”/“non-precipitation” classification of the measurements), for example, by using the same neural network and by integrating data measured at different polarizations or frequencies into it.

The next step involves inverting these values to determine an intensity of precipitation (R(t),t) (step 120) corresponding to the inverse function of the fluctuation values (ΔP(t),t). For the case of rain, it is possible to determine the rainfall rate R by applying the following scheme (step 60):
Acquisition of the altitude Zo of the 0° C. isotherm
Calculation of Lo, the distance traveled by the signal below the 0° C. isotherm, as a function of the altitude Zo and the geometry of the problem
Determination of the rainfall rate

$${R ( t )}_{t} = \sqrt[b]{\frac{k , \vert Δ {P ( t )}_{t} \vert}{Lo}}$$

Where:
R denotes the rainfall rate in millimeters per hour
Lo denotes the distance traveled by the signal below the 0° C. isotherm
ΔP(t) denotes the fluctuation of the received power in decibels
b and k denote coefficients depending mainly on the frequency, the polarization of the radiofrequency signal, and the drop size distribution. Other parameters linked to the geometry of the problem (angle of incidence of the wave on the drops, for example) and environmental parameters (water temperature, for example) are also likely to influence them to a lesser extent.

In the context of this patent, taking measurements at a plurality of frequencies and under a plurality of polarizations will make it possible to obtain information on the characteristic sizes of the raindrops. Specifically, the attenuation caused by the rain is directly related to the drop size distribution as well as to the effective extinguishing cross section of the drops. This section is itself a function of the diameter of the drops, their shape and the polarization of the wave in question, according to Mie scattering theory. For example, free-falling drops are not spherical, but flattened. They will therefore have a greater extinguishing section, and hence cause a greater attenuation, the more the wave that touches them is in a horizontal polarization (with respect to the ground). Assuming a fixed relationship between the shape and diameter of the drops (more flattened the larger they are), taking measurements on the same rain at a plurality of polarizations makes it possible to calculate differential attenuations (for example, ratio of the attenuations obtained in horizontal and vertical polarizations) and from there to access information on the drop size distribution (deducing, for example, moments from this distribution). Note that for this purpose it is necessary to transform the horizontal and vertical components of the LNB head (normally adjusted to those of the satellite) to horizontal and vertical components with respect to the ground before comparing the measurement differences. Advantageously, these components should also be corrected by taking into account the trajectory of the drops and the angle of incidence of the wave with respect to the vertical and to the trajectory of the drops.

This same work can be done more directly by calculating differential attenuations on measurements with the same polarization but at different frequencies/frequency bands.

Advantageously, these different determination methods can be merged.

6. Exploitation of Signals from Acquisition Devices: Rendering of Rain Maps

The processing operations below are carried out centrally, on a server, and aim to produce a map of the rainfall at ground level (step 140).

1/First, the Speed of Movement of the Precipitation Cells is Estimated (Step 190).

This speed can be learned (step 80) from one of the following data sources, or advantageously, to improve the precision and robustness of the estimate, by merging a plurality of these data sources:
a direct estimate from the temporal fluctuation series of the received power recorded by the various sensors.

One solution for this involves estimating, for each pair of sensors, a delay (“lag”) between the start dates of precipitation at each of the sensors, and then deducing the displacement of the precipitation cells from the delays by triangulation for all the pairs of sensors (knowing their positions).
an indirect estimate from satellite images of the cloud masses (step 160).

One solution for this comprises estimating displacement vectors from cloud images obtained in real time by geostationary meteorological satellites.
modeling of the wind at altitude by meteorological models (step 150).

Digital weather prediction operational models simulate wind at altitude. This wind is assumed to be representative of the speed of movement of clouds and precipitation cells.

2/the Rainfall Measurements Performed by Each Sensor are Projected onto the Ground (Step 130).

This projection is implemented by taking into account the position of the sensor, the altitude Zo of the 0° isotherm, the rate of fall of the raindrops, and the speed of movement of the rain cells (step 65).

For example, it is known that the raw measurement taken by a given sensor targeting a geostationary satellite corresponds to the average rainfall over a segment a few kilometers long (up to the 0° isotherm), at an angle of about 40° to the ground (example from France).

The part of the measurement corresponding to the high end of the segment will correspond to a rainfall at ground level obtained a few minutes later (time for the drops to fall) and a little further in the direction of the cell movement (since the drops do not fall perpendicular to the ground).

The rate of fall of the raindrops (step 170) can advantageously be adjusted according to the characteristic size of the raindrops deduced from the measurements carried out on different polarizations/frequency bands (step 200) by applying theoretical and/or empirical relationships between the size of the drops and the rate of fall (step 70).

3/the Rain Map on the Ground is Rendered (Step 90).

This step comprises, on the date t, optimally merging the measurements taken by a set of sensors over a period [t−T:t] to produce a map of the rain on the ground over the region around the sensors over the same period [t−Tf:t], where 1/Tf denotes the frequency at which this data merging step is periodically repeated.

This step (step 90) may also, in addition to the rainfall measurements taken by the method described above, integrate rainfall data measured by other instruments (for example, rain gauges, meteorological radars, meteorological satellites, opportunistic data deduced, for example, from webcam images).

This step (step 90) may advantageously be carried out using a data assimilation algorithm, for example, of the 4D-VAR type.

This algorithm may include a model A(t,Tf) that simulates the development of the rain cells from the date t−Tf to the date T and that takes as a parameter the speed of movement of the rain cells.

This algorithm takes as input the rainfall measurements from the sensors projected on the ground according to point 2/and provides as output the rainfall maps on the ground over the period [t−Tf:t].

An algorithm of this type is also particularly well-suited for merging data from different types of instruments (radars, rain gauges, etc.) as indicated above by defining observation operators (and associated errors) that simulate the measurements taken by these instruments from rainfall maps at ground level.

Variant

An advantageous variant comprises exploiting the radiofrequency signal emitted by the raindrops themselves, which emit a signal over the entire electromagnetic spectrum in accordance with Planck's law and/or which backscatter the electromagnetic waves crossing the region of their presence in accordance with Mie's theory. The measurement will then preferably be taken on the Ku band, and will be of the radiometric type. In this case, the fluctuation in the measured signal thus records a radio signal surplus due to the emission of the raindrops. The rain level R(t) is then determined in accordance with the aforementioned method but with coefficients b and k determined empirically from calibrations carried out with other instruments for measuring rain.

1. A method for measuring precipitation, comprising:
acquiring, from at least one coordinate (x,y,z) acquisition site PA, at least one radio signal transmitted from at least one transmitter and periodically measuring the power P(t) of a component of the received signal to create series of time-stamped levels (P(t),t);
performing processing, over at least one sliding temporal window, of N values of at least one time-stamped series (P(t),t), comprising determining the type of hydrometeors that are in play and determining a reference level for the signal corresponding to the power of the signal that would be received from the transmitter in the absence of hydrometeors and denoted (Pref(t),t); and
calculating a sequence of power fluctuations due to rainfall or due to other hydrometeors (ΔP(t),t) in accordance with:
ΔP(t)=P(t)−Pref(t).

2. The method of claim 1, wherein the processing over at least one sliding temporal window is applied to the time-stamped series (P(t),t) combined with other time series (Mp(t),t) of environmental parameters at or close to the acquisition site and of parameters relating to the system.

3. The method of claim 2, wherein the parameters (Mp(t),t) are used to correct the measurement taken to eliminate unwanted contributions.

4. The method of claim 3, wherein one or more additional time series (Mp(t),t) are created from the existing series (P(t),t) and (Mp(t),t) for a set of stations.

5. The method of claim 1, the determination of the reference level for the signal is carried out simultaneously or otherwise with the identification of the hydrometeors that are in play by performing processing including:
determining the start or end dates of the period with precipitation as a function of the variance, of the speed of variations, and of the signature of the values (P(t),t); and
determining Pref(t) in accordance with the following cases:
between the start tdj and end tfj times of periods with precipitation, Pref(t) corresponding to an interpolation between (P(tdj),tdj) and (P(tfj),tfj); and
between the end time of precipitation tfj and the start time of following precipitation tdj+1:
Pref(t)=P(t)
after a start of precipitation tdj the corresponding end of which has not yet been detected:
Pref(t)=P(tdj))

6. The method of claim 5, wherein the step of determining the start and end of the period of precipitation is carried out by a neural network.

7. The method of claim 2, wherein the determination of the reference level (Pref(t),t) is carried out by a neural network that takes as input the time series (P(t),t) and the other parameters (Mp(t),t), that is trained against reference data (radar or rain gauge) and that provides the reference level (Pref(t),t) as output.

8. The method of claim 7, wherein the neural network is a recurrent LSTM (long short-term memory) network.

9. The method of claim 1, further comprising:
acquiring the altitude Zo of the 0° C. isotherm;
calculating Lo, the distance traveled by the signal below the 0° C. isotherm, as a function of the altitude Zo and the geometry of the problem;
determining the rainfall rate
$${R ( t )}_{t} = \sqrt[b]{\frac{k , \vert Δ {P ( t )}_{t} \vert}{Lo}}$$
Where:
R denotes the rainfall rate in millimeters per hour;
Lo denotes the distance traveled by the signal below the 0° C. isotherm;
ΔP(t) denotes the fluctuation of the received power in decibels; and
b and k denote coefficients depending on the frequency, the polarization of the radiofrequency signal, and the drop size distribution.

10. The method of claim 1, wherein the transmitter of the measured radio signal is a satellite.

11. The method of claim 1, wherein the radio signal transmitted from at least one radiofrequency transmission source is formed by the signal emitted by raindrops.

12. The method of claim 9, further comprising producing a precipitation map by determining, for a plurality of acquisition devices STATIONᵢ, the average precipitation rates R(t), and then performing a mapping step comprising carrying out a projection on the ground of the rainfall rates R(t)ᵢ as a function of the altitude Zo of the 0° C. isotherm.

13. The method of claim 12, wherein the processing is carried out for each acquisition device STATIONᵢ and the projections on the ground of the rainfall rate Rx,y,z(t) are determined as a function of:
the attenuation values (ΔP(t),t)ᵢ corresponding to the devices STATIONᵢ, and
the length Loᵢ(t) of the segment of the STATIONᵢ-transmitter link Eᵢ between the ground and the altitude Zo(t) of the 0° C. isotherm.

14. The method of claim 13, wherein the step of determining the projections on the ground of the rainfall rate R_{x,y,z}(t) is also a function of time and of the fall direction of the drops in the volume comprising the positions of the devices.

15. The method of claim 12, wherein the step of acquiring at least one radio signal transmitted from at least one radiofrequency transmitter and periodically measuring the power of the signal is performed by an acquisition device STATIONᵢ, comprising a module having an input for receiving the signal coming from a radiofrequency reception antenna, a component that selects a useful part of the signal by transposing it to a lower frequency band, an electronic circuit for measuring the level of the input signal and calculating a digital value representing the level, and communication device for distributing a digital message comprising the digital value.

16. The method of claim 12, wherein a computer controls processing operations comprising:
estimating the speed of movement of cells by a direct estimate from temporal data ΔP(t)i of fluctuations in received power, calculated from the data P(t)ᵢ measured by the various measurement stations PAᵢ that are geolocated (x,y,z)i and recorded by the different sensors;
calculating a projection on the ground of the rainfall measurements taken by each measurement station PAᵢ, taking into account the position of the sensor, the altitude Zo of the 0° isotherm, the rate of fall of the raindrops, and the speed of movement of the rain cells; and
periodically, at a frequency 1/Tf, rendering the rain map on the ground by a step of merging the measurements taken by a significant number of measurement stations STATIONᵢ, over a period [t−T:t] (where T>Tf), to produce a ground rainfall map over the region around the sensors over the period [t−Tf:t].

17. The method of claim 16, wherein the estimate of the speed of movement of the rain cells comprises at least one of:
estimating, for each pair of measurement stations (STATIONᵢ; STATIONⱼ), the delay (“lag”) between the start dates of precipitation at each of the sensors, and then deducing the displacement of the rain cells from the delays by triangulation for all pairs of measurement stations;
producing the estimate from satellite images of cloud masses; or
modeling the wind at altitude using meteorological models.

18. The method of claim 16, wherein the step of merging the measurements taken by a significant number of measurement stations STATIONᵢ is carried out by data assimilation processing as a function of a model representing the state of the atmosphere A(t).

19. The method of claim 16, wherein the step of merging the measurements taken comprises mergin data of different types and coming from different types of instruments.

20. An acquisition device for implementing the method according to claim 1, comprising an input for receiving the signal from a radiofrequency reception antenna, an electronic circuit for measuring the level of the input signal calculating a digital value representing the level, and a communication device for the distributing a digital message comprising at least one of the following elements:
the digital image value of the power;
an identifier IDᵢ of the acquisition device STATIONᵢ;
the instantaneous position of the STATIONᵢ;
information on the measured components of the signals;
information on the transmitter(s) listened to;
information relating to local weather conditions; and
information relating to the results of calculations carried out locally.

21. The device of claim 20, wherein the radiofrequency reception antenna comprises a satellite dish equipped with an LNB universal head.

22. The device of claim 20, further comprising:
a photovoltaic system including a solar panel, a battery and an electronic controller; and
a radiofrequency communication device.

23. The device of claim 22, further comprising a circuit for placing the radiofrequency communication device on standby, controlled by a signal representing the presence of precipitation in the sight of the device, by information coming from the network, or by the state of the station, as a function of the amount of energy present in the battery and expected availability of the energy source.

24. The device of claim 20, further comprising means for periodically switching off the LNB head.

25. The device of claim 24, further comprising means for adjusting the periodicity of switching off the LNB head as a function of a signal representing the presence of precipitation in the sight of the device, as a function of information from the network or as a function of the status of the station.

26. The device of claim 20, further comprising means for controlling the periodic variation of the polarization and/or of the frequency band of the LNB head, in order to measure components of the received signal.

27. The device of claim 20, further comprising a thermal protection means for the LNB head and batteries of the power supply.

28. The device of claim 20, further comprising at least one sensor providing the computer with local parameters.
